(19) United States
(12) Patent Application Publication
(10) Pub. No.: US 2024/0426719 A1
(43) Pub. Date: Dec. 26, 2024

(54) METHOD FOR ANALYZING MAGNETIC MATERIALS IN LITHIUM HYDROXIDE MONOHYDRATE

(71) Applicant: ENERGYSOURCE MINERALS, LLC, Carlsbad, CA (US)

(72) Inventor: Carlos Maria Valerio, Carlsbad, CA (US)

(73) Assignee: ENERGYSOURCE MINERALS, LLC, Carlsbad, CA (US)

(21) Appl. No.: 18/750,686

(22) Filed: Jun. 21, 2024

Related U.S. Application Data
(60) Provisional application No. 63/510,114, filed on Jun. 24, 2023.

(51) Int. Cl. G01N 1/38; G01N 1/40; G01N 1/44; G01N 21/71; H01J 49/10

(52) U.S. Cl. CPC G01N 1/38; G01N 1/4077; G01N 1/44; G01N 21/718; H01J 49/105; G01N 2001/386

(57) ABSTRACT

The invention generally relates to a method for analyzing magnetic impurities and materials in lithium hydroxide monohydrate. Any magnetic materials (e.g., Cr, Fe, Co, Nd, Ni, Sm, and other rare earth elements) in the lithium hydroxide monohydrate (LHM) are recovered by a neodymium, glass-encased magnetic stir bar and then subjected to acid digestion. The digested LHM samples are analyzed using Inductively Coupled Plasma-Optical Emission Spectroscopy (ICP-OES) or Inductively Coupled Plasma-Mass Spectrometry (ICP-MS). The inventive method provides a standardized procedure for analyzing or measuring magnetic impurities in the LHM samples to determine if the LHM end product meets a lithium-ion battery manufacturer's specifications for battery-grade lithium hydroxide monohydrate.

### CROSS-REFERENCE TO RELATED APPLICATIONS

This application claims the benefit of U.S. Provisional Patent Application No. 63/510,114, filed on Jun. 24, 2023, and said provisional application is incorporated by reference in its entirety into this document as if fully set out at this point.

### BACKGROUND OF THE INVENTION

### 1. Field of the Invention

The subject matter disclosed herein relates to a method for analyzing magnetic impurities and materials in lithium hydroxide monohydrate.

### 2. Description of the Related Art

The growing demand for lithium in various applications, particularly lithium-ion batteries, means that lithium-bearing brines are becoming increasingly attractive as new energy resources. Brines from mineral clays, petro-brines, Smackover brines, continental brines, and geothermal brines are expected to provide increasingly higher amounts of lithium to the battery metals market. In addition to lithium, these brines are rich sources of other alkali metals, alkaline earth metals, and transition metals.

While lithium extraction and concentration processes are efficient at separating lithium from other alkali metals, alkaline earth metals, and transition metals in these brine resources, magnetic impurity materials can remain in the end product. Unfortunately, there is no standardized procedure for analyzing or measuring magnetic impurities in order to determine if the end product meets lithium-ion battery manufacturers' specifications for battery-grade lithium hydroxide monohydrate.

### SUMMARY OF THE INVENTION

The invention relates to a method for analyzing magnetic impurities and materials in lithium hydroxide monohydrate. With the increasing value of lithium in the marketplace and the drive to produce more lithium-ion batteries, the inventive method quickly and efficiently analyzes and determines magnetic impurities and materials in lithium hydroxide monohydrate. The inventive method provides for repeatability and reliability to meet product specifications for battery-grade lithium hydroxide monohydrate.

In general, in a first aspect, the invention relates to a method for analyzing magnetic impurities and materials in lithium hydroxide monohydrate (“LHM”). The method includes mixing a dried LHM sample and a first volume of deionized water in a laboratory glassware using a magnetic stir bar for a predetermined mixing time and at a predetermined mixing speed to form a first LHM mixture, and then transferring the magnetic stir bar to a centrifuge tube. The magnetic stir bar in the centrifuge tube is acid digested using a second volume of deionized water and a strong acid at a predetermined predigesting temperature for a predetermined predigesting time to form a second LHM mixture. The second LHM mixture is heated in the centrifuge tube at a predetermined heating temperature for a predetermined heating time to form a first LHM solution. The magnetic stir bar is removed from the centrifuge tube, and then a third volume of deionized water is added to the first LHM solution in the centrifuge tube to form a second LHM solution. The second LHM solution is mixed/shaken in the centrifuge tube. Elemental analysis is then performed to determine if the second LHM solution meets predetermined battery-grade specifications for magnetic impurities and materials in LHM.

In an embodiment, the magnetic impurities and materials are Cr, Fe, Co, Ni, Nd, Sm, other rare earth elements, or any combination thereof.

In an embodiment, each of the volumes of the deionized water is about 18.2 MΩ·cm.

In an embodiment, the magnetic stir bar is a neodymium iron boron (“NdFeB”) magnet, a grain boundary diffusion neodymium magnet, a ferrite magnet, a samarium cobalt (“SmCo”) magnet, or an aluminum, nickel, and cobalt (“AlNiCo”) magnet encased in borosilicate glass.

In an embodiment, the magnetic stir bar has a strength of more than 10,000 Gauss.

In an embodiment, the magnetic stir bar has a cylindrical (with or without a pivot ring), octagonal, triangular, oval, crosshead, double-ended, ergonomic, or single or double-finned configuration.

In an embodiment, the method also includes drying a sample of LHM in an inert atmosphere at a predetermined drying temperature (e.g., about 110° C.) for a predetermined drying time (e.g., about one hour) to form the dried LHM sample.

In an embodiment, the laboratory glassware is a low-thermal-expansion borosilicate glass beaker.

In an embodiment, the predetermined mixing time is about 30 minutes, and the mixing speed is a medium stir speed sufficient to generate a one-half vortex at a surface of the first LHM mixture.

In an embodiment, the method also includes decanting the first LHM mixture.

In an embodiment, the strong acid is ultrapure hydrochloric acid, nitric acid, or a mixture thereof, such as an HCl concentration of about 36% to about 38% and a HNO₃ concentration of about 66% to about 70%.

In an embodiment, the predigesting temperature is ambient temperature, and the predigesting time is about 15 minutes.

In an embodiment, the predetermined heating temperature is a setting on a laboratory hotplate or a heated water bath with a temperature greater than about 110° C., and wherein the predetermined heating time is about 15 minutes.

In an embodiment, the method also includes determining a magnetic impurities and materials concentration of Cr, Fe, Co, Ni, Nd, Sm, other rare earth elements, or any combination thereof in the second LHM solution, and determining whether the concentration meets the predetermined battery-grade specifications for magnetic impurities and materials in LHM.

In an embodiment, the elemental analysis is performed using Inductively Coupled Plasma-Optical Emission Spectroscopy (ICP-OES) or Inductively Coupled Plasma-Mass Spectrometry (ICP-MS).

In an embodiment, ICP standards are prepared per the table below:

| | | | 1000 | 1000 | 1000 | 1000 | 1000 | 1000 |
|---|---|---|---|---|---|---|---|---|
| | cHCl | cHNO₃ | μg/ml Cr | μg/ml Fe | μg/ml Co | μg/ml Nd | μg/ml Ni | μg/ml Sm |
| | Required | Required | Required | Required | Required | Required | Required | Required |
| | (ml) | (ml) | (ml) | (ml) | (ml) | (ml) | (ml) | (ml) |
| Calibration Blank (Calib. Blk; Matrix: | 25 | 25 | 0 | 0 | 0 | 0 | 0 | 0 |
| 2.5% HCl, 2.5% HNO₃) | | | | | | | | |
| Standard 1 (0.01 μg/ml Cr, Fe, Co, | 25 | 25 | 0.01 | 0.01 | 0.01 | 0.01 | 0.01 | 0.01 |
| Nd, Ni, Sm; Matrix: 2.5% HCl, 2.5% | | | | | | | | |
| HNO₃) | | | | | | | | |
| Standard 2 (0.02 μg/ml Cr, Fe, Co, | 25 | 25 | 0.02 | 0.02 | 0.02 | 0.02 | 0.02 | 0.02 |
| Nd, Ni, Sm; Matrix: 2.5% HCl, 2.5% | | | | | | | | |
| HNO₃) | | | | | | | | |
| Standard 3 (0.10 μg/ml Cr, Fe, Co, | 25 | 25 | 0.10 | 0.10 | 0.10 | 0.10 | 0.10 | 0.10 |
| Nd, Ni, Sm; Matrix: 2.5% HCl, 2.5% | | | | | | | | |
| HNO₃) | | | | | | | | |
| Initial Calibration Verification (ICV, | 25 | 25 | 0.02 | 0.02 | 0.02 | 0.02 | 0.02 | 0.02 |
| 0.02 μg/ml Cr, Fe, Co, Nd, Ni, Sm; | | | | | | | | |
| Matrix: 2.5% HCl, 2.5% HNO₃) | | | | | | | | |

In general, in a second aspect, the invention relates to a method for analyzing magnetic impurities and materials in a LHM analyte. The method includes mixing a LHM sample and a first volume of deionized water using a glass-encased magnetic stir bar (e.g., in a low-thermal-expansion borosilicate glass beaker) for about 30 minutes and at a predetermined mixing speed to form a first LHM mixture, wherein the predetermined mixing speed is sufficient to generate a one-half vortex at a surface of the first LHM mixture. The first LHM mixture is decanted, and the magnetic stir bar is transferred to an elemental analyzer sample tube (e.g., centrifuge tube). A second volume of deionized water and a strong acid is used to acid digest the magnetic stir bar at an ambient temperature for up to about 15 minutes to form a second LHM mixture, and then the second LHM mixture is heated in the sample tube at a temperature greater than about 110° C. for about 15 minutes to form a first LHM solution. The magnetic stir bar is removed from the sample tube, and a third volume of deionized water is added to the first LHM solution in the sample tube to form a second LHM solution. Elemental analysis is performed to determine a magnetic impurities and materials concentration of Cr, Fe, Co, Ni, Nd, Sm, other rare earth elements, or any combination thereof in the second LHM solution. The inventive method then determines if the concentration meets a predetermined battery-grade specification for magnetic impurities and materials in LHM.

In an embodiment, each of the volumes of the deionized water is about 18.2 MΩ·cm.

In an embodiment, the magnetic stir bar is a neodymium iron boron (“NdFeB”) magnet, a grain boundary diffusion neodymium magnet, a ferrite magnet, a samarium cobalt (“SmCo”) magnet, or an aluminum, nickel, and cobalt (“AlNiCo”) magnet encased in borosilicate glass.

In an embodiment, the magnetic stir bar has a strength of more than 10,000 Gauss.

In an embodiment, the magnetic stir bar has a cylindrical (with or without a pivot ring), octagonal, triangular, oval, crosshead, double-ended, ergonomic, or single or double-finned configuration.

In an embodiment, the method includes drying a sample of LHM in an inert atmosphere at a predetermined drying temperature of about 110° C. for about one hour to form the LHM sample.

In an embodiment, the strong acid is ultrapure hydrochloric acid, nitric acid, or a mixture thereof.

In an embodiment, the hydrochloric acid has a concentration of about 36% to about 38%, and the nitric acid has a concentration of about 66% to about 70%.

In an embodiment, the elemental analysis uses Inductively Coupled Plasma-Optical Emission Spectroscopy (ICP-OES) or Inductively Coupled Plasma-Mass Spectrometry (ICP-MS).

In an embodiment, ICP standards are prepared per the table below:

| | | | 1000 | 1000 | 1000 | 1000 | 1000 | 1000 |
|---|---|---|---|---|---|---|---|---|
| | cHCl | cHNO₃ | μg/ml Cr | μg/ml Fe | μg/ml Co | μg/ml Nd | μg/ml Ni | μg/ml Sm |
| | Required | Required | Required | Required | Required | Required | Required | Required |
| | (ml) | (ml) | (ml) | (ml) | (ml) | (ml) | (ml) | (ml) |
| Calibration Blank (Calib. Blk; Matrix: | 25 | 25 | 0 | 0 | 0 | 0 | 0 | 0 |
| 2.5% HCl, 2.5% HNO₃) | | | | | | | | |
| Standard 1 (0.01 μg/ml Cr, Fe, Co, | 25 | 25 | 0.01 | 0.01 | 0.01 | 0.01 | 0.01 | 0.01 |
| Nd, Ni, Sm; Matrix: 2.5% HCl, 2.5% | | | | | | | | |
| HNO₃) | | | | | | | | |
| Standard 2 (0.02 μg/ml Cr, Fe, Co, | 25 | 25 | 0.02 | 0.02 | 0.02 | 0.02 | 0.02 | 0.02 |
| Nd, Ni, Sm; Matrix: 2.5% HCl, 2.5% | | | | | | | | |
| HNO₃) | | | | | | | | |
| Standard 3 (0.10 μg/ml Cr, Fe, Co, | 25 | 25 | 0.10 | 0.10 | 0.10 | 0.10 | 0.10 | 0.10 |
| Nd, Ni, Sm; Matrix: 2.5% HCl, 2.5% | | | | | | | | |
| HNO₃) | | | | | | | | |
| Initial Calibration Verification (ICV, | 25 | 25 | 0.02 | 0.02 | 0.02 | 0.02 | 0.02 | 0.02 |
| 0.02 μg/ml Cr, Fe, Co, Nd, Ni, Sm; | | | | | | | | |
| Matrix: 2.5% HCl, 2.5% HNO₃) | | | | | | | | |

In an embodiment, the method also includes preparing a second LHM analyte as a method duplicate.

In an embodiment, the method also includes preparing a method blank of deionized water only with a magnetic stir bar.

### BRIEF DESCRIPTION OF THE DRAWINGS

The above and other objects and advantages of this invention may be more clearly seen when viewed in conjunction with the accompanying drawing wherein:

FIG. 1 is a flowchart of an example of a method for analyzing magnetic impurities and materials in accordance with an exemplary embodiment of the invention.

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

The invention generally relates to a method for analyzing magnetic impurities and materials in lithium hydroxide monohydrate (LHM). Any magnetic materials (e.g., Cr, Fe, Co, Nd, Ni, Sm, and other rare earth elements) in the LHM are recovered by a glass-encased magnetic stir bar and then subjected to acid digestion. The magnetic stir bar can be a neodymium iron boron (“NdFeB”) magnet, a grain boundary diffusion neodymium magnet, a ferrite magnet, a samarium cobalt (“SmCo”) magnet, an aluminum, nickel, and cobalt (“AlNiCo”) magnet, or other permanent magnet encased in borosilicate glass, and the magnetic stir bar can have a strength of more than 10,000 Gauss. PTFE-encased stir bars are not recommended with the inventive method since magnetic material from PTFE-encased stir bars is leached during acid digestion at high temperatures, resulting in false positives for magnetic materials. The magnetic stir bar provides both the magnetic flux as well as the mixing action (dual purpose). The magnetic stir bar can have a cylindrical (with or without a pivot ring), octagonal, triangular, oval, crosshead, double-ended, ergonomic, single- or double-finned, or other suitable external configuration. The digested LHM analyte is analyzed using Inductively Coupled Plasma-Optical Emission Spectroscopy (ICP-OES) or Inductively Coupled Plasma-Mass Spectrometry (ICP-MS), and the inventive method then determines from the ICP elemental analysis if the LHM sample meets a lithium-ion battery manufactures specification for the magnetic materials for the battery-grade LHM.

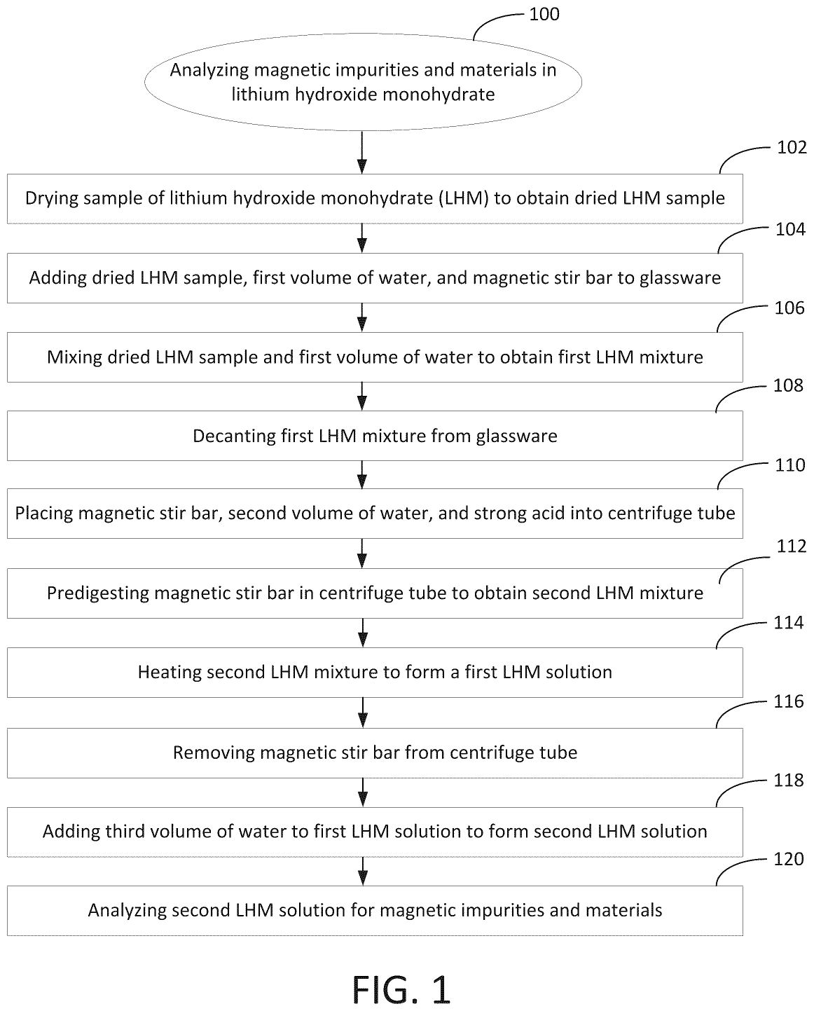

In accordance with an exemplary embodiment, FIG. 1 depicts a method 100 for analyzing magnetic impurities and materials in LHM, which begins with the step 102 of drying a sample of LHM to obtain a dried LHM sample. The sample of LHM is dried in an inert atmosphere at a predetermined drying temperature for a predetermined drying time. The predetermined drying temperature may be about 110° C., and the predetermined drying time may be about one hour. It will be appreciated that, in some embodiments, a dried LHM sample is obtained directly from a third-party supplier or other source, thereby obviating the need to dry the LHM sample at step 102.

Turning to step 104, a portion or all of the dried LHM sample is added to a laboratory glassware, along with a first volume of deionized water (e.g., about 18.2 MΩ·cm) and a glass-encased magnetic stir bar, which is used to stir the dried LHM sample and the first volume of deionized water for a predetermined mixing time and at a predetermined mixing speed to form a first LHM mixture (step 106). Suitable laboratory glassware includes, for example, a low-thermal-expansion borosilicate glass beaker. The predetermined mixing time may be about 30 minutes, and the predetermined mixing speed may be a medium stir speed sufficient to generate a one-half vortex at a surface of the first LHM mixture. At step 108, the first LHM mixture is decanted from the laboratory glassware, followed by removal of the stir bar from the laboratory glassware.

The stir bar is transferred into a centrifuge tube with a second volume of deionized water and a strong acid treatment (step 110). The strong acid treatment may be additions of ultrapure hydrochloric acid (HCl), ultrapure nitric acid (HNO₃), or both. In one non-limiting embodiment, the strong acid has a concentration of about 36% to about 38% HCl and a concentration of about 66% to about 70% HNO₃. After the second volume of deionized water and the strong acid are introduced, the magnetic stir bar in the centrifuge tube is predigested at a predetermined predigesting temperature for a predetermined predigesting time to obtain a second LHM mixture (step 112). The predetermined predigesting temperature may be ambient temperature, and the predetermined predigesting time may be about 15 minutes. At step 114, the second LHM mixture is heated in the centrifuge tube at a predetermined heating temperature for a predetermined heating time to form a first LHM solution. The second LHM mixture may be heated by capping the centrifuge tube and placing the capped centrifuge tube onto a laboratory hotplate with a medium heating/temperature setting or within a heated water bath. Suitable predetermined heating temperatures include temperatures greater than 110° C. The predetermined heating time may be about 15 minutes.

After removing the centrifuge tube from the hotplate, heated water bath, or other heating source and uncapping the centrifuge tube, the magnetic stir bar is removed from the centrifuge tube at step 116, leaving behind the first LHM solution. Stir bar removal may be accomplished, for example, with a magnetic stir bar retriever by attracting one end of the stir bar by placing the stir bar perpendicular to the centrifuge tube and dragging the stir bar parallel until out of the first LHM solution and the centrifuge tube. At step 118, a third volume of deionized water is added into the uncapped centrifuge tube with the first LHM solution to form a second LHM solution, the centrifuge tube is capped, and the centrifuge tube with the second LHM solution is mixed with shaking.

The second LHM solution is analyzed for magnetic impurities and materials at step 120 using, e.g., ICP-OES or ICP-MS. The centrifuge tube, once uncapped, is available for elemental analysis and can be placed into an autosampler of the applicable ICP instrumentation. Based on the analysis in step 122, it can be determined whether the second LHM solution in the centrifuge tube meets predetermined specifications for the magnetic impurities and materials for the battery-grade LHM.

### Examples

The method for analyzing magnetic impurities and materials in lithium hydroxide monohydrate is further illustrated by the following examples, which are provided for the purpose of demonstration rather than limitation.

Approximately 30 g of a dry LHM sample is placed into a drying oven set at 110° C. in an inert atmosphere for one hour. From the oven, 20±0.1 g of the dried LHM sample is weighted on a digital mass balance and placed into a 2 L beaker. A second dried LHM sample is prepared as a duplicate. Approximately 1.8 L of deionized water (18.2 MΩ·cm only) and a clean, neodymium glass (borosilicate)-encased magnetic stir bar (in excess of 10,000 Gauss) are added to each beaker. For a method blank, 2 L of deionized water only with the stir bar is added to a beaker. The beakers are respectively placed on magnetic stirrers and agitated (or stirred) for 30 minutes at a medium speed that will generate a one-half vortex at the surface of the mixture. Each mixture is then decanted, and the magnetic start bars are removed and respectively placed in a 50 ml metal-free centrifuge tube. Twenty (20) ml of deionized water is added to each centrifuge tube, followed by additions of 15 ml HCl and 5 ml HNO₃. The strong acids are ultrapure grade having a concentration of about 36% to about 38% for hydrochloric acid and about 66% to about 70% for nitric acid. Predigestion of the uncapped centrifuge tubes is allowed at ambient temperature for 15 minutes, and then capped centrifuge tubes are placed onto a hotplate (set to accommodate them) with a medium heating/temperature setting. The samples are then heated for 15 minutes. A heated water bath set with a temperature greater than 110° C. is also acceptable. Heating settings on either the hotplate or heated water bath must not be high enough to result in a vigorous boil in either the sample matrix and/or the water bath.

The heated samples are removed from the hotplate/heated water bath, and each of the centrifuge tubes is uncapped. Using a magnetic stir bar retriever, one end of the stir bar is attracted by placing it perpendicular to the centrifuge tube, and the stir bar is dragged parallel until out of solution and tube. With the magnetic stir bar removed, 10 ml of deionized water is added, and the centrifuge tubes are recapped and mixed by shaking the centrifuge tubes. After shaking, the centrifuge tubes are uncapped and placed into the ICP instrumentation for elemental analysis. The ICP instrumentation is equipped with an autosampler, a computer for instrumentation control and data export, a chiller, and an adequate supply of high-purity Argon (liquid). An autoinjector is recommended for high-throughput samples, and other additions and/or requirements may be utilized based on the manufacturer's recommendations and/or laboratory management.

Table 1 below summarizes reagent quantities to make up the necessary standards.

TABLE 1

| | | | 1000 | 1000 | 1000 | 1000 | 1000 | 1000 |
|---|---|---|---|---|---|---|---|---|
| | cHCl | cHNO₃ | μg/ml Cr | μg/ml Fe | μg/ml Co | μg/ml Nd | μg/ml Ni | μg/ml Sm |
| | Required | Required | Required | Required | Required | Required | Required | Required |
| | (ml) | (ml) | (ml) | (ml) | (ml) | (ml) | (ml) | (ml) |
| Calibration Blank (Calib. Blk; Matrix: | 25 | 25 | 0 | 0 | 0 | 0 | 0 | 0 |
| 2.5% HCl, 2.5% HNO₃) | | | | | | | | |
| Standard 1 (0.01 μg/ml Cr, Fe, Co, | 25 | 25 | 0.01 | 0.01 | 0.01 | 0.01 | 0.01 | 0.01 |
| Nd, Ni, Sm; Matrix: 2.5% HCl, 2.5% | | | | | | | | |
| HNO₃) | | | | | | | | |
| Standard 2 (0.02 μg/ml Cr, Fe, Co, | 25 | 25 | 0.02 | 0.02 | 0.02 | 0.02 | 0.02 | 0.02 |
| Nd, Ni, Sm; Matrix: 2.5% HCl, 2.5% | | | | | | | | |
| HNO₃) | | | | | | | | |
| Standard 3 (0.10 μg/ml Cr, Fe, Co, | 25 | 25 | 0.10 | 0.10 | 0.10 | 0.10 | 0.10 | 0.10 |
| Nd, Ni, Sm; Matrix: 2.5% HCl, 2.5% | | | | | | | | |
| HNO₃) | | | | | | | | |
| Initial Calibration Verification (ICV, | 25 | 25 | 0.02 | 0.02 | 0.02 | 0.02 | 0.02 | 0.02 |
| 0.02 μg/ml Cr, Fe, Co, Nd, Ni, Sm; | | | | | | | | |
| Matrix: 2.5% HCl, 2.5% HNO₃) | | | | | | | | |

The calibration blank acts as Initial Calibration Blank (ICB) and Continuous Calibration Blank (CCB) for quality control (QC) instrument checks. Standard 1 acts as Low-Level Initial Calibration Verification (LLICV) for QC instrument check, and Standard 2 acts as Continuous Calibration Verification (CCV) QC instrument check. The ICV must be prepared with stock standards of a different manufacturer/source. ICP standards are prepared in a 1 L Class A volumetric flask, which has been rinsed with concentrated acid and deionized water. The internal standard for ICP analysis is preferably 10 μg/ml Sc or Y, but other alternatives (i.e., Be or In) may also be valid, so long as it does not cause any spectral interferences in the analysis.

As a result of metal elemental analysis by ICP-OES or ICP-MS, the inventive method determines if the LHM meets end product specifications for battery-grade LHM, namely the concentration of the magnetic impurities is below a battery manufacturer's specifications for such materials. The inventive method provides for a standardized procedure for analyzing or measuring magnetic impurities to determine if the LHM end product meets the lithium-ion battery manufacturers' specifications for battery-grade lithium hydroxide monohydrate.

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted as a range whose lower limit is 25 and whose upper limit is 100. Additionally, it should be noted that where a range is given, every possible subrange or interval within that range is also specifically intended unless the context indicates the contrary. For example, if the specification indicates a range of 25 to 100, such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only, and decimal and fractional values (e.g., 46.7-91.3) should also be understood to be intended as possible subrange endpoints unless specifically excluded.

It should be understood that the exemplary embodiments described above should be considered in a descriptive sense only and not for purposes of limitation. Descriptions of features or aspects within these embodiments should typically be considered as available for other similar features or aspects in other embodiments.

While one or more embodiments have been described with reference to the figures, it will be understood by those of ordinary skill in the art that various changes in form and details may be made therein without departing from the scope of the inventive concept as defined by the following claims.

What is claimed is:

1. A method for analyzing magnetic impurities and materials in lithium hydroxide monohydrate (“LHM”), the method comprising the steps of:
mixing a dried LHM sample and a first volume of deionized water in a laboratory glassware using a magnetic stir bar for a predetermined mixing time and at a predetermined mixing speed to form a first LHM mixture;
transferring the magnetic stir bar to a centrifuge tube;
predigesting the magnetic stir bar in the centrifuge tube using a second volume of deionized water and a strong acid at a predetermined predigesting temperature for a predetermined predigesting time to form a second LHM mixture;
heating the second LHM mixture in the centrifuge tube at a predetermined heating temperature for a predetermined heating time to form a first LHM solution;
removing the magnetic stir bar from the centrifuge tube;
adding a third volume of deionized water to the first LHM solution in the centrifuge tube to form a second LHM solution and mixing the second LHM solution in the centrifuge tube; and
performing elemental analysis to determine if the second LHM solution meets predetermined battery-grade specifications for magnetic impurities and materials in LHM.

2. The method of claim 1, wherein the magnetic impurities and materials are Cr, Fe, Co, Ni, Nd, Sm, other rare earth elements, or any combination thereof.

3. The method of claim 1, wherein each of the volumes of the deionized water is about 18.2 MΩ·cm.

4. The method of claim 1, wherein the magnetic stir bar is a neodymium iron boron (“NdFeB”) magnet, a grain boundary diffusion neodymium magnet, a ferrite magnet, a samarium cobalt (“SmCo”) magnet, or an aluminum, nickel, and cobalt (“AlNiCo”) magnet encased in borosilicate glass.

5. The method of claim 4, wherein the magnetic stir bar has a strength of more than 10,000 Gauss.

6. The method of claim 1, wherein the magnetic stir bar has a cylindrical (with or without a pivot ring), octagonal, triangular, oval, crosshead, double-ended, ergonomic, or single or double-finned configuration.

7. The method of claim 1 further comprising the step of drying a sample of LHM in an inert atmosphere at a predetermined drying temperature for a predetermined drying time to form the dried LHM sample.

8. The method of claim 7, wherein the predetermined drying temperature is about 110° C. and the predetermined drying time is about one hour.

9. The method of claim 1, wherein the laboratory glassware is a low-thermal-expansion borosilicate glass beaker.

10. The method of claim 1, wherein the predetermined mixing time is about 30 minutes, and the mixing speed is a medium stir speed sufficient to generate a one-half vortex at a surface of the first LHM mixture.

11. The method of claim 1, wherein the step of transferring the magnetic stir bar further comprises decanting the first LHM mixture.

12. The method of claim 1, wherein the strong acid is ultrapure hydrochloric acid, nitric acid, or a mixture thereof.

13. The method of claim 11, wherein the hydrochloric acid has a concentration of about 36% to about 38% and the nitric acid has a concentration of about 66% to about 70%.

14. The method of claim 1, wherein the predigesting temperature is ambient temperature, and the predigesting time is about 15 minutes.

15. The method of claim 1, wherein the predetermined heating temperature is a setting on a laboratory hotplate or a heated water bath with a temperature greater than about 110° C., and wherein the predetermined heating time is about 15 minutes.

16. The method of claim 1, wherein the step of performing the elemental analysis further comprises determining a magnetic impurities and materials concentration of Cr, Fe, Co, Ni, Nd, Sm, other rare earth elements, or any combination thereof in the second LHM solution, and determining whether the concentration meets the predetermined battery-grade specifications for magnetic impurities and materials in LHM.

17. The method of claim 15, wherein the step of performing the elemental analysis further comprises performing the elemental analysis using Inductively Coupled Plasma-Optical Emission Spectroscopy (ICP-OES) or Inductively Coupled Plasma-Mass Spectrometry (ICP-MS).

18. The method of claim 1 further comprising the step of preparing ICP standards per the table below:

| | | | 1000 | 1000 | 1000 | 1000 | 1000 | 1000 |
|---|---|---|---|---|---|---|---|---|
| | cHCl | cHNO₃ | μg/ml Cr | μg/ml Fe | μg/ml Co | μg/ml Nd | μg/ml Ni | μg/ml Sm |
| | Required | Required | Required | Required | Required | Required | Required | Required |
| | (ml) | (ml) | (ml) | (ml) | (ml) | (ml) | (ml) | (ml) |
| Calibration Blank (Calib. Blk; Matrix: | 25 | 25 | 0 | 0 | 0 | 0 | 0 | 0 |
| 2.5% HCl, 2.5% HNO₃) | | | | | | | | |
| Standard 1 (0.01 μg/ml Cr, Fe, Co, | 25 | 25 | 0.01 | 0.01 | 0.01 | 0.01 | 0.01 | 0.01 |
| Nd, Ni, Sm; Matrix: 2.5% HCl, 2.5% | | | | | | | | |
| HNO₃) | | | | | | | | |
| Standard 2 (0.02 μg/ml Cr, Fe, Co, | 25 | 25 | 0.02 | 0.02 | 0.02 | 0.02 | 0.02 | 0.02 |
| Nd, Ni, Sm; Matrix: 2.5% HCl, 2.5% | | | | | | | | |
| HNO₃) | | | | | | | | |
| Standard 3 (0.10 μg/ml Cr, Fe, Co, | 25 | 25 | 0.10 | 0.10 | 0.10 | 0.10 | 0.10 | 0.10 |
| Nd, Ni, Sm; Matrix: 2.5% HCl, 2.5% | | | | | | | | |
| HNO₃) | | | | | | | | |
| Initial Calibration Verification (ICV, | 25 | 25 | 0.02 | 0.02 | 0.02 | 0.02 | 0.02 | 0.02 |
| 0.02 μg/ml Cr, Fe, Co, Nd, Ni, Sm; | | | | | | | | |
| Matrix: 2.5% HCl, 2.5% HNO₃) | | | | | | | | |

19. A method for analyzing magnetic impurities and materials in a lithium hydroxide monohydrate (“LHM”) analyte, the method comprising the steps of:
mixing a LHM sample and a first volume of deionized water using a glass-encased magnetic stir bar for about 30 minutes and at a predetermined mixing speed to form a first LHM mixture, wherein the predetermined mixing speed is sufficient to generate a one-half vortex at a surface of the first LHM mixture;
decanting the first LHM mixture and transferring the magnetic stir bar to an elemental analyzer sample tube;
predigesting the magnetic stir bar in the sample tube using a second volume of deionized water and a strong acid at an ambient temperature for up to about 15 minutes to form a second LHM mixture;
heating the second LHM mixture in the sample tube at a temperature greater than about 110° C. for about 15 minutes to form a first LHM solution;
removing the magnetic stir bar from the sample tube;
adding a third volume of deionized water to the first LHM solution in the sample tube to form a second LHM solution and mixing the second LHM solution in the sample tube;
performing the elemental analysis to determine a magnetic impurities and materials concentration of Cr, Fe, Co, Ni, Nd, Sm, other rare earth elements, or any combination thereof in the second LHM solution; and
determining whether the concentration meets a predetermined battery-grade specification for magnetic impurities and materials in LHM.

20. The method of claim 19, wherein each of the volumes of the deionized water is about 18.2 MΩ·cm.

21. The method of claim 19, wherein the magnetic stir bar is a neodymium iron boron (“NdFeB”) magnet, a grain boundary diffusion neodymium magnet, a ferrite magnet, a samarium cobalt (“SmCo”) magnet, or an aluminum, nickel, and cobalt (“AlNiCo”) magnet encased in borosilicate glass.

22. The method of claim 21, wherein the magnetic stir bar has a strength of more than 10,000 Gauss.

23. The method of claim 21, wherein the magnetic stir bar has a cylindrical (with or without a pivot ring), octagonal, triangular, oval, crosshead, double-ended, ergonomic, or single or double-finned configuration.

24. The method of claim 19 further comprising the step of drying a sample of LHM in an inert atmosphere at a predetermined drying temperature of about 110° C. for about one hour to form the LHM sample.

25. The method of claim 19, wherein the strong acid is ultrapure hydrochloric acid, nitric acid, or a mixture thereof.

26. The method of claim 25, wherein the hydrochloric acid has a concentration of about 36% to about 38% and the nitric acid has a concentration of about 66% to about 70%.

27. The method of claim 19, wherein the step of performing the elemental analysis further comprises performing the elemental analysis using Inductively Coupled Plasma-Optical Emission Spectroscopy (ICP-OES) or Inductively Coupled Plasma-Mass Spectrometry (ICP-MS).

28. The method of claim 19 further comprising the step of preparing ICP standards per the table below:

| | | | 1000 | 1000 | 1000 | 1000 | 1000 | 1000 |
|---|---|---|---|---|---|---|---|---|
| | cHCl | cHNO₃ | μg/ml Cr | μg/ml Fe | μg/ml Co | μg/ml Nd | μg/ml Ni | μg/ml Sm |
| | Required | Required | Required | Required | Required | Required | Required | Required |
| | (ml) | (ml) | (ml) | (ml) | (ml) | (ml) | (ml) | (ml) |
| Calibration Blank (Calib. Blk; Matrix: | 25 | 25 | 0 | 0 | 0 | 0 | 0 | 0 |
| 2.5% HCl, 2.5% HNO₃) | | | | | | | | |
| Standard 1 (0.01 μg/ml Cr, Fe, Co, | 25 | 25 | 0.01 | 0.01 | 0.01 | 0.01 | 0.01 | 0.01 |
| Nd, Ni, Sm; Matrix: 2.5% HCl, 2.5% | | | | | | | | |
| HNO₃) | | | | | | | | |
| Standard 2 (0.02 μg/ml Cr, Fe, Co, | 25 | 25 | 0.02 | 0.02 | 0.02 | 0.02 | 0.02 | 0.02 |
| Nd, Ni, Sm; Matrix: 2.5% HCl, 2.5% | | | | | | | | |
| HNO₃) | | | | | | | | |
| Standard 3 (0.10 μg/ml Cr, Fe, Co, | 25 | 25 | 0.10 | 0.10 | 0.10 | 0.10 | 0.10 | 0.10 |
| Nd, Ni, Sm; Matrix: 2.5% HCl, 2.5% | | | | | | | | |
| HNO₃) | | | | | | | | |
| Initial Calibration Verification (ICV, | 25 | 25 | 0.02 | 0.02 | 0.02 | 0.02 | 0.02 | 0.02 |
| 0.02 μg/ml Cr, Fe, Co, Nd, Ni, Sm; | | | | | | | | |
| Matrix: 2.5% HCl, 2.5% HNO₃) | | | | | | | | |

29. The method of claim 19 further comprises the step of preparing a second LHM analyte as a method duplicate.

30. The method of claim 19 further comprises the step of preparing a method blank of deionized water only with a magnetic stir bar.
